(19) United States
(12) Patent Application Publication
(10) Pub. No.: US 2016/0139775 A1
(43) Pub. Date: May 19, 2016

(54) SYSTEM AND METHOD FOR INTERACTIVE AUDIO/VIDEO PRESENTATIONS

(71) Applicant: Touchcast LLC, New York, NY (US)

(72) Inventor: Edo Segal, New York, NY (US)

(21) Appl. No.: 14/942,865

(22) Filed: Nov. 16, 2015

Related U.S. Application Data
(60) Provisional application No. 62/080,013, filed on Nov. 14, 2014.

(51) Int. Cl. G06F 3/0484; G06F 3/16; G06F 3/00

(52) U.S. Cl. CPC G06F 3/04842; G06F 3/005; G06F 3/167

(57) ABSTRACT

An electronic user interface is provided and at least one selection made in the user interface is processed that defines a threshold value. A digital media library of multimedia content is accessed, by the at least one processor, that includes at least one of audio and video content to provide via the user interface at least some of the digital multimedia content. Further, user input is received, via at least one sensor configured with the at least one computing device, and the received user input is processed to determine that the received user input exceeds the threshold value. Thereafter, the at least one processor provides a revised version of the digital multimedia content substantially automatically by incorporating at least some of the received user input, and a digital package is generated that includes the digital multimedia content and the at least some of the received user input.

### CROSS-REFERENCE TO RELATED PATENT APPLICATIONS

This application is based on and claims priority to U.S. Provisional Patent Application 62/080,013, filed Nov. 14, 2014, the entire contents of which is incorporated by reference herein as if expressly set forth in its respective entirety herein.

### TECHNICAL FIELD OF THE INVENTION

This disclosure relates generally to the field of interaction with an audio video simulation environment, and, in particular, to systems and methods for single-user control of interacting with a multimedia simulation program.

### BACKGROUND OF THE INVENTION

Various multimedia programs and games are presently available which allow the user to simulate and/or participate in the playing/recording of music. For instance, many video games (such as GUITAR HERO® and ROCK BAND®) enable one or more users to simulate the playing of various musical instruments (such as guitar, drums, keyboard, etc.) through interaction with video game controllers. Furthermore, certain versions of these games on various video gaming platforms allow the user to utilize specially constructed controllers which more accurately simulate the playing style of the instrument they represent.

In order to further simulate the ‘band’ experience, some games allow for the simultaneous connection of multiple specialized controllers (for instance, one guitar-controller, one keyboard-controller, and one drum kit—controller). In such a scenario, each of the individual players selects one controller/instrument to play, and the users play together simultaneously as a virtual “band.”

A conceptually similar idea is at work in the well-known field of karaoke. In karaoke, a machine plays an instrumental recording of well-known song wherein the vocal track(s) are removed. A display screen simultaneously presents the lyrics of the song to the user in coordination with the progression of the song being played. One or more users are provided with microphones, using the microphones to provide the vocal element(s) of the song. Audio and/or video recording of the user's performance of the song is also possible in certain systems.

While known multimedia simulation games enable multiple users to simulate the playing of multiple instruments simultaneously, no such platform exists for enabling a single user to achieve multi-instrument gameplay. Furthermore, no platform currently exists for enabling a single user interface to record multiple instruments.

It is with respect to these and other considerations that the disclosure made herein is presented.

### SUMMARY OF THE INVENTION

Technologies are presented herein for a system and method for enhancing interaction with a multimedia simulation program. Various aspects, features, and advantages can be appreciated from the accompanying description of certain embodiments of the invention and the accompanying drawing figures.

In one or more arrangements, a system and method are provided that include providing, by at least one processor configured with at least one computing device, an electronic user interface. At least one selection made in the user interface is processed that defines a threshold value associated with user input. A digital media library of multimedia content is accessed, by the at least one processor, that includes at least one of audio and video content to provide, via the user interface, at least some of the digital multimedia content. Further, user input is received, via at least one sensor configured with the at least one computing device, and the received user input is processed to determine that the received user input exceeds the threshold value. Thereafter, the at least one processor provides a revised version of the digital multimedia content substantially automatically by incorporating at least some of the received user input, and a digital package is generated that includes the digital multimedia content and the at least some of the received user input. The digital package can be transmitted, via a communication interface, to at least one other computing device.

In one or more arrangements, the threshold value represents a maximum volume level, and the received user input that exceeds the threshold value is audio detected by a microphone that is operatively configured with the at least one computing device. At least some of the audio detected by the microphone can be a person speaking or singing.

In one or more arrangements, the threshold value represents a maximum difference between adjacent image frames in video detected by a camera configured with the at least one computing device, and the received user input that exceeds the threshold value includes video detected by the camera.

In one or more arrangements, the threshold value represents a maximum amount of movement of the at least one computing device detected by at least one motion sensor.

These and other aspects, features, and arrangements can be better appreciated from the accompanying description of the drawing figures of certain embodiments of the invention.

### BRIEF DESCRIPTION OF THE DRAWINGS

FIG. 1 shows an example hardware arrangement for viewing, reviewing and outputting content in accordance with an implementation;

FIGS. 2A and 2B illustrated high-level interactions and operational flow of a multimedia computing device in accordance with an exemplary embodiment; and

FIG. 3 is a flow diagram illustrating a method in accordance with an example implementation.

### DESCRIPTION

The following description is directed to systems and methods for enhancing interaction with a music and/or video program. References are made to the accompanying drawings that form a part hereof, and which are shown by way of illustration through specific embodiments, arrangements, and examples.

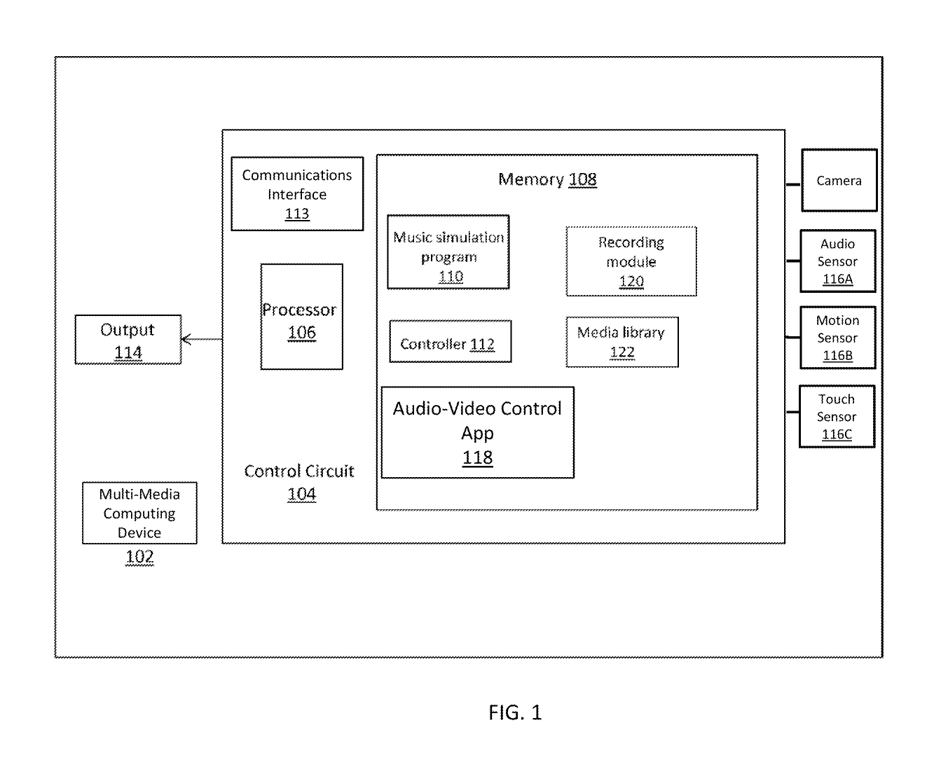

Referring now to the drawings, it is to be understood that like numerals represent like elements through the several figures, and that not all components and/or steps described and illustrated with reference to the figures are required for all embodiments or arrangements. FIG. 1 is a high-level diagram illustrating an exemplary configuration of a multimedia computing device 102. In one or more arrangements, multimedia computing device 102 can be a personal media device (such as an MAD® or IPOD®), a smartphone (such as an IPHONE® or a computing device configured with the ANDROID®, WINDOWS® or other operating system), personal computer, or any other such device capable of embodying the systems and/or methods described herein. It should be noted that in alternate arrangements, various elements of multimedia computing device 102 can be distributed across several connected components, such as in the case of an XBOX®, PLAYSTATION® or other gaming system.

Multimedia computing device 102 includes a control circuit 104 which is operatively connected to various hardware and software components that can enable and/or enhance interaction with a multimedia simulation program. The control circuit 104 is operatively connected to a processor 106 and a memory 108. Memory 108 can be accessible by processor 106, thereby enabling processor 106 to receive and execute instructions stored on memory 108, or distributed across one or more other devices.

In one or more arrangements, memory 108 has a multimedia simulation program 110 stored thereon. The multimedia simulation program 110 can include one or more software components, applications, and/or modules that is/are executable by processor 106. In one or more arrangements, multimedia simulation program 110 configures device 102 to include an interactive music and/or video player that dynamically alternates between playback of a plurality of versions of recorded and/or captured audio and/or video. Multimedia simulation program 110 can configure multimedia computing device 102 to enable playback and/or recording of one or more audio and/or video tracks. Dynamic alternating of playback between different versions of the audio and/or video content can, for example, effectively switch between a “full” version of a performance that includes all recorded components (e.g., instruments and vocals) and a “karaoke” version of the performance that has at least one of the recorded components eliminated. In addition to audio content, simulation program 110 configures device 102 to alternate video content as well, for example, from pre-recorded video content to include “live” video content that is captured by a camera that is configured with or otherwise operating with device 102.

In one or more arrangements, simulation program 110, when executed by processor 106, configures multimedia computing device 102 to access and/or interact with one or more media library 122. Media library 122 can include audio and/or video files and/or tracks, and respective content in medial library 122 can be accessed as a function of a user selection or indication, such as made in simulation program 110. Multimedia simulation program 110 can include one or more instructions to configure device 1202 to access files and/or tracks within library 122, and play one or more of them for the user, and can further access captured audio and/or video content via device 102. Multimedia simulation program 110 can further configure device 102 to record and store new files and/or tracks, and/or modify existing files and/or tracks. In an alternate arrangement, multimedia simulation program 110 can be pre-loaded with audio and/or video files or tracks, and thus not require further access to media library 122. In operation, multimedia simulation program can configure device 102 to enable user-interaction with one or more of songs and/or videos for a prescribed duration of the song and/or the video, including in a manner shown and described herein.

Also stored or encoded on memory 108 can be controller 112. In one or more arrangements, controller 112 can be configured to include one or more software components, applications, and/or modules that is/are executable by processor 106. Controller 112 can be coupled, operatively or otherwise, with multimedia simulation program 110, and that further enables enhanced interaction with multimedia simulation program 110. Controller 112 can configure multimedia computing device 102 to operate in one of a plurality of interactive modes to provide one or more outputs 114 to a user. The various interactive modes can include one or more musical instruments, and/or a microphone (that is, a vocal mode). Prior to and during the duration of the one or more audio and/or video files or tracks, the user can select from among the various interactive modes.

In one or more arrangements, multi-media computing device is configured with communication interface 113. Communication interface 113 can be any interface that enables communication between the device 102 and external devices, machines and/or elements. Preferably, communication interface 113 includes, but is not limited to, a modem, a Network Interface Card (NIC), an integrated network interface, a radio frequency transmitter/receiver, an infrared port, a USB connection, or any other such interfaces for connecting device 102 to other devices. Such connections can include a wired connection or a wireless connection (e.g. 802.11) though it should be understood that communication interface 113 can be practically any interface that enables communication to/from the control circuit.

In one or more arrangements, a plurality of sensors, such as audio sensor 116A, motion sensor 116B and touch sensor 116C, can be configured to sense input and be operatively connected to control circuit 104. Audio sensor 116A can include, for example, a microphone and/or speaker. Motion sensor 116B can include, for example, an movement sensing device such as a gyroscope, accelerometer, audio detection camera, or any other such device or combination of devices capable of sensing, detecting, and/or determining varying degrees of movement. Touch sensor 116C can include, for example, a touch capacitive device, such as to receive input at a particular location in a graphical display screen, such as a graphical button.

Continuing with reference to the example implementation shown in FIG. 1, an audio-video control application 118 is stored/encoded on memory 108. The audio-video control application 118 can include one or more software components, applications, and/or modules that is/are executable by processor 106. Upon execution, the audio-video control application 118 configures control circuit 104, in response to one or more inputs (e.g., audio sensor 116A, motion sensor 116B and/or touch sensor 116C), to generate a selection-control signal based on the received input, and to switch the controller 112 from one interactive mode to another interactive mode. That is, in response to a particular input from one or more of sensors 116A-C (such as detecting that the user is singing or speaking above a predefined volume level), audio-video control application 118 generates a selection-control signal which directs controller 112 and/or multimedia simulation program 110 to switch the operation of controller 112 from one interactive mode to another interactive mode.

In one or more arrangements, a threshold value is set that represents the predefined level. The threshold value can represent, for example, a volume level, a video level (e.g., changes between individual and/or adjacent image frames within captured video), and a degree of movement associated with multimedia computing device 102. For example, audio sensor 16A detects from input that a volume received via a microphone is above the threshold value, and instructions can be executed to generate the selection-control signal and switch the controller 112 from one mode to another. Input that is received, such as via sensor 16A, 16B and/or 16C, is processed and one or more digital commands are generated and executed. For example, a user selects a graphical slider control via a user interface operating on multimedia computing device 102 to set a threshold volume level of 4. As content plays on device 102, the user begins to speak or sing at a volume louder than the threshold value 5, and the user's voice replaces at least one of the vocal parts in the recording. Thus, the one of the vocal parts can be effectively substituted by the user's voice.

By way of example, no particular input from any of sensors 116A-C can correspond to the selection of a non-interactive, playback mode of audio and/or video content. When sensor 116A-C senses input, such as audio input via a microphone, a particular gesture (such as the rotation of multimedia computing device 102 90 degrees), a detection from a camera that the user has moved a minimum amount or in a particular way, a tap of a button provided on a display, or other suitable input, an input is provided that is received by audio-video control application 118. In response, audio-video control application 118 operates to generate a selection-control signal which directs controller 112 and/or multimedia simulation program 110 to switch the operation of controller 112 substantially automatically (e.g., without additional human interaction or involvement) away from a current mode to an interactive mode.

In operation, the user can interact with the multimedia computing device 102 that is executing multimedia simulation program 110. During the execution of multimedia simulation program 110, such as during the duration of a song or video, the user can sing, tap, gesture or otherwise activate sensor 116A-C. The sensor 116A-C sends, and the audio-video control application 118 receives an input which corresponds to the user's voice, distinctive gesture or movement. In response, the audio-video control application 118 generates a selection-control signal which serves to switch the controller from a first mode to a second interactive mode. For example, the controller is switched to an audio/video karaoke mode and the user can sing along with a music video and have video of himself/herself recorded simultaneously. This user interaction with the controller, including any switching between various interactive modes, which occurs during the duration of the song or video, as well as the results of these interactions, are included in the output to the user (e.g., output to a video display and/or audio projection device). Thus, the user's interaction with the multimedia simulation program 110 is enhanced in that the user can sing, gesture or move multimedia computing device 102 and thereby switch between one or more interactive modes seamlessly and without any interruption to the ongoing duration of the song or video being played.

It should be noted that the sounds, gestures or movements that are detected by sensor 116A-C and in turn received by audio-video control application 118, as described above, can be customized based on a variety of criteria. While various gestures/movements are assigned default settings, the user can further edit or modify these settings, and/or define new gestures or movements, and may further change the association between a particular gesture and a particular interactive mode/instrument. Further, one or more various microphone levels can be set that, when exceeded, cause audio-video control application 118 to operate in an interactive way or, otherwise, not react.

It should be further noted that a recording module 120 can be stored or encoded on memory 108. In one or more arrangements, recording module 120 is a software program, application, and/or one or more modules that is/are executable by processor 106. Recording module 120 enables the recording and storage of music/sound and/or video tracks and/or files that are generated though user interaction with multimedia computing device 102 in the manner described herein. Recording module 120 can be a software program that is operatively coupled with multimedia simulation program 110, and that further enables enhanced interaction with multimedia simulation program 110, though in certain arrangements recording module 120 can stand alone and operate independently, without the presence of the multimedia simulation program 110. The recorded songs, videos, and/or tracks can be stored in media library 122, or in another user specified storage location.

By way of example, multimedia simulation program 110 can be configured to execute while augmenting a previously recorded song, video, or track with a further recording, using recording module 120. In doing so, the user may add additional audio and/or video elements (such as additional instrumental or vocal tracks, or additional video elements) that are incorporated within the previously recorded song/video, thereby creating an updated/enhanced version of the previously recorded song/video. Recording module 120 can store the updated/enhanced songs/videos in media library 122, or elsewhere, either by overwriting the previously recorded song/video, or by saving updated/enhanced version as new file/set of files.

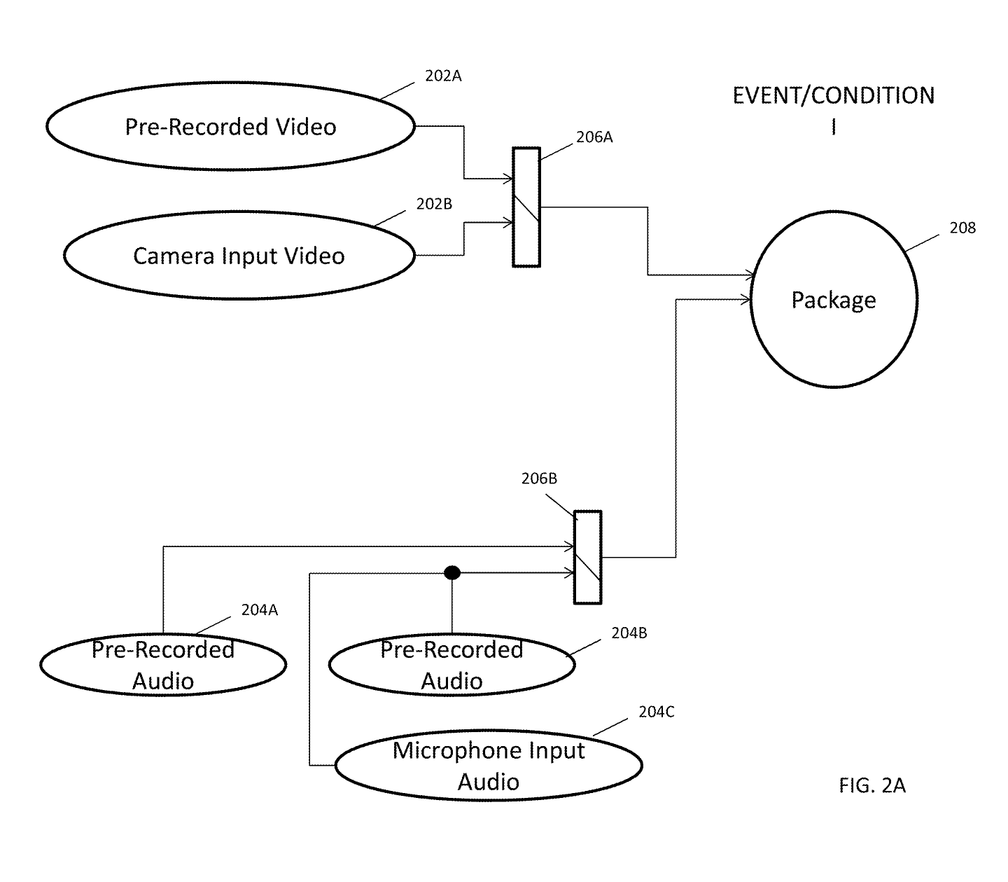

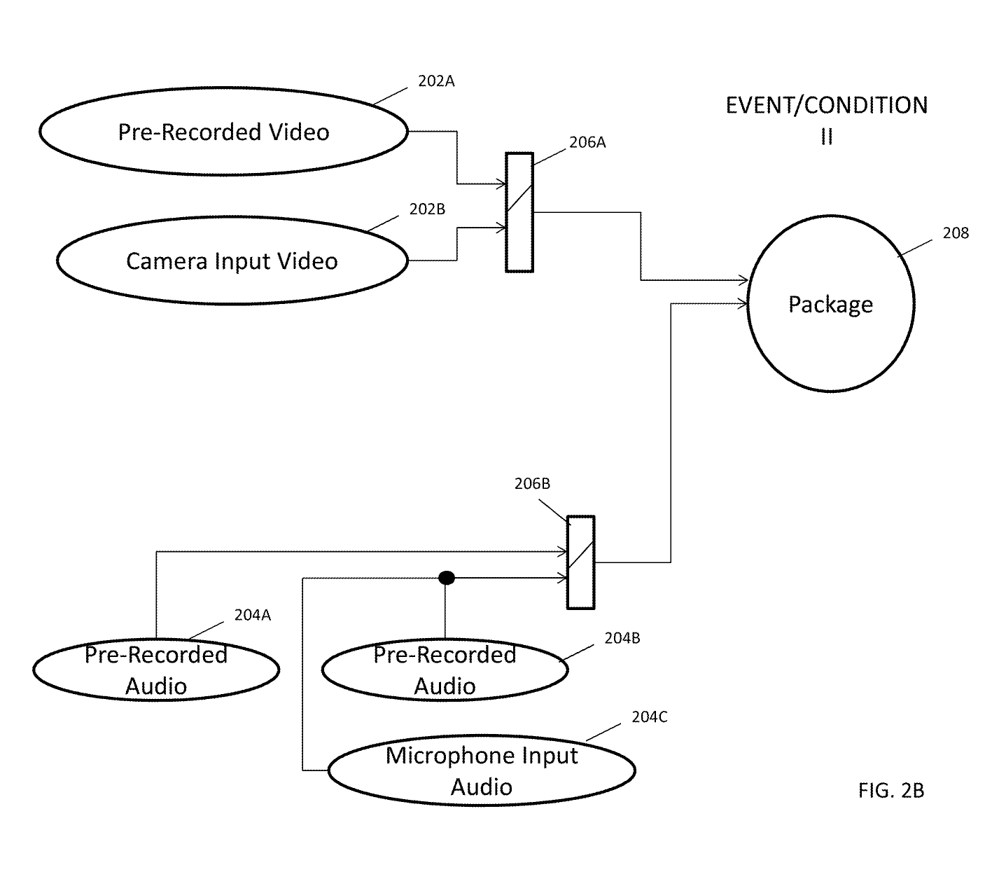

Referring now to FIGS. 2A and 2B, several of modules and processes are illustrated that represent functionality in accordance with an example implementation of the present application. Pre-recorded video content 202A, which may include video content stored in a library, and camera input video content 202B can be provided in the creation of a package 208. Package 208 can be, for example, provided to a user of device 102 substantially in real time, and can further be recorded and stored for future viewing, and can include a video recording. In addition, prerecorded audio content 204A and prerecorded audio content 204B can be provided as well. In one or more implementations, audio content 204A represents a “full” mixed version of a song, including vocals and all instrument tracks, and audio content 204B represents a “karaoke” version of the song, with the vocal track(s) and/or one or more instrument tracks removed or reduced in volume. In addition, microphone input content 204C, such as sensed by audio sensor 116A, is further provided. Also illustrated in FIGS. 2A and 2B are gates 206A and 206B which operate to enable or preclude content from being provided in the package 208. As can be appreciated by the examples shown in FIGS. 2A and 2B, the respective gates 206A and 206B are in different positions, which correspond to the respective event/condition that is detected (“Event/Condition I” or “Event/Condition II”). The respective event/conditions can relate, for example, to input sensed by one or more sensors 116A-C, and the gates 206A and/or 206B can be controlled as a function of instructions executed via audio-video control application 118 in response thereto.

For example, and with reference to FIG. 2A, a user starts playback of a music video on the multimedia computing device 102. The respective event/condition I is that no relevant input is sensed by one or more sensors 116A-C, and accordingly, pre-recorded video content 202A and pre-recorded audio content 204A is provided to package 208. Referring now to FIG. 2B, an event or condition occurs and is sensed, such as by one or more sensors 116A-C, which results in audio-video control application 118 modifying the behavior of gates 206A/B, thereby precluding the pre-recorded video content 202A and the pre-recorded audio content 204A from package 208. The event or condition may be, for example, that the user of device 102 begins speaking or singing in or near the microphone configured or associated with device 102. Alternatively (or in addition), the event or condition may be that the user moved (e.g., rotated, shook or took some other physical actions) device 102 by a certain amount, which was sensed by motion sensor 116B. Alternatively (or in addition), the user pressed a button displayed or otherwise configured with device 102, such as a physical button for activating a camera configured or otherwise associated with device 102 and sensed by touch sensor 116C.

Continuing with reference to FIG. 2B, upon recognition of event/condition II, video content 202B, such as provided by camera configured or otherwise associated with device 102, replaces the content 202A, for example, during the time of the event/condition II. Upon recognition of event/condition I, the operation of device 102 alternates and the pre-recorded video content 202A replaces the camera input video 202B, for example, during that time. Similarly, as video content 202B replaces content 202A during the event/condition II, the pre-recorded audio 204A (which may represent a “full” mix of a song that includes, for example, vocals and all instrument (and other audio) tracks), is replaced by the pre-recorded audio 204B, which may be a karaoke version of the song that omits (or at least lowers in volume) one or more tracks, such as vocal tracks from the pre-recorded audio 204A. Moreover, during the event/condition II, audio content 204C that is received from a microphone that is configured or otherwise associated with device 102, is mixed with the pre-recorded audio 204B and provided to package 208 for example, during the time that event/condition II occurs. Upon occurrence of event/condition I (e.g., the user stops speaking or singing), then the pre-recorded audio 204A replaces the mixed pre-recorded audio 204B and microphone input audio 204C (and/or pre-recorded video 202A replaces the camera input video 202B). Thus, the present application results in seamless alternating between pre-recorded video and captured video (e.g., vis-à-vis a camera) and one version of pre-recorded audio 204A (e.g., a full mix of a song) and another version of pre-recorded audio 204B mixed with input audio 204C (e.g., vis-à-vis a microphone), as a function of determining that an event occurs (e.g., a person singing, a person turning device 102, and/or a person pressing a button).

Although the representation in FIGS. 2A and 2B represent gates 208A and 208B as forms of switches, the application is not so limited. Various other suitable ways of precluding content to package 208 are supported herein, such as by raising and lowering volume levels dynamically and/or brightening and darkening video or portions of video dynamically and on the basis of a determination of a respective event/condition (e.g., I or II). Moreover, package 208 may be provided substantially in real time to the device 102, while being saved and/or recorded for future use and playback. Furthermore, the saved package 208 can be transmitted, including by device 102, to another computing device for future use and playback. The saved package 208 can be further modified in accordance with the teachings herein by another device 102 so configured and to provide additional customization.

In addition, although the implementation shown in FIGS. 2A and 2B represents functionality for switching one source of content for another, other functionality is supported herein for providing alternating operations of device 102. For example, individual audio tracks of a recording (e.g., bass, guitar, drums, keyboards and vocals) may be stored and dynamically replaced in response to input from a user, such as when the user sings. In such implementation, the vocal track may drop out as the user sings and be replaced by the input captured by the microphone at the time. When the user stops singing, the stored vocal track resumes and in time. Various processing may be required in such an implementation, including to adjust for a time lag or other delay. In one or more implementations, such time lag may be precluded by buffering playback of the pre-recorded music video before providing the playback on the user's device 102. Thereafter, as the user interacts with the device 102, processing can occur and the experience can appear to be seamless for the user.

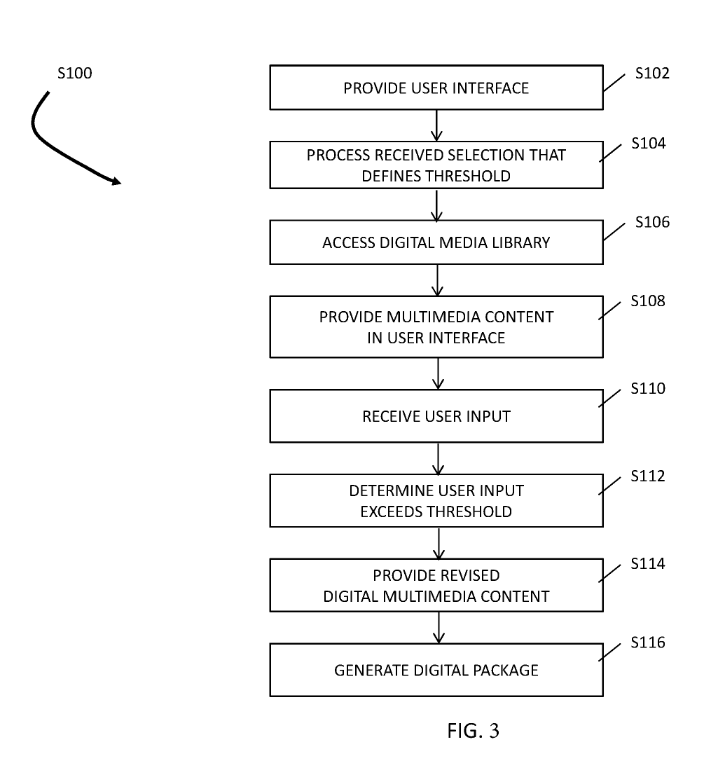

FIG. 3 is a flow diagram illustrating a routine S100 that illustrates a broad aspect of a method for generating a digital multimedia package, in accordance with at least one embodiment disclosed herein. It should be appreciated that several of the logical operations described herein are implemented (1) as a sequence of computer implemented acts or program modules running on computing device 102 and/or (2) as interconnected machine logic circuits or circuit modules within the device 102. The implementation can be a matter of choice, including but not limited to being dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The routine S100 begins at block S102 and includes providing, by at least one processor configured with at least one computing device, an electronic user interface. At least one selection made in the user interface is processed that defines a threshold value associated with user input (step S104). A digital media library of multimedia content is accessed, by the at least one processor, that includes at least one of audio and video content to provide via the user interface at least some of the digital multimedia content (steps S106, S108). Further, user input is received, via at least one sensor configured with the at least one computing device (step S110). The received user input is processed to determine that the received user input exceeds the threshold value (step S112). Thereafter, the at least one processor provides a revised version of the digital multimedia content substantially automatically by incorporating at least some of the received user input (step S114). Thereafter, a digital package is generated that includes the digital multimedia content and the at least some of the received user input (step S116).

It should be noted that the flow shown in FIG. 3 is exemplary and the blocks can be implemented in a different sequence in variations within the scope of the invention.

In one or more implementations, the present application can be usable in connection with drama. For example, media library 122 can include content associated with a dramatic work (e.g., a play) and the present application is usable for users to be substituted for one or more parts. Such implementations are useful, for example, in an education environment.

The subject matter described herein is provided by way of illustration only and should not be construed as limiting. Various modifications and changes can be made to the subject matter described herein without following the example embodiments and applications illustrated and described, and without departing from the true spirit and scope of the present invention.

What is claimed is:

1. A computer-implemented method, the method comprising:
providing, by at least one processor configured with at least one computing device, an electronic user interface;
processing, by the at least one processor, at least one selection made in the user interface that defines a threshold value associated with user input;
accessing, by the at least one processor, a digital media library of multimedia content that includes at least one of audio and video content to provide, via the user interface, at least some of the digital multimedia content;
receiving, via at least one sensor configured with the at least one computing device, user input;
processing, by the at least one processor, the received user input to determine that the received user input exceeds the threshold value;
providing, substantially automatically by the at least one processor, a revised version of the digital multimedia content that is provided via the user interface by incorporating at least some of the received user input; and
generating, by the at least one processor, a digital package that includes the digital multimedia content and the at least some of the received user input.

2. The method of claim 1, further comprising transmitting, by the at least one processor via a communication interface, the digital package to at least one other computing device.

3. The method of claim 1, wherein the threshold value represents a maximum volume level, and the received user input that exceeds the threshold value is audio detected by a microphone that is operatively configured with the at least one computing device.

4. The method of claim 3, wherein at least some of the audio detected by the microphone is a person speaking or singing.

5. The method of claim 1, further comprising:
selecting, by the at least one processor in response to the processed received user input, at least some other of the digital multimedia content from the digital medial library, and wherein the package includes the at least some other of the digital multimedia content.

6. The method of 5, wherein the provided at least some of the digital multimedia content via the user interface includes a first version of a multimedia content, and further wherein the at least other of the digital multimedia content includes a second version of the multimedia content.

7. The method of claim 6, wherein the first version includes at least one audio and/or video portion, and wherein the second version includes less than the at least one audio and/or video portion.

8. The method of claim 1, further comprising controlling, by the at least one processor, a gate that enables or disables at least some of the multimedia content from the digital media library from being provided via the user interface.

9. The method of claim 1, wherein the threshold value represents a maximum difference between adjacent image frames in video detected by a camera configured with the at least one computing device, and the received user input that exceeds the threshold value includes video detected by the camera.

10. The method of claim 1, wherein the threshold value represents a maximum amount of movement of the at least one computing device detected by at least one motion sensor configured with the at least one computing device.

11. A computer-implemented system, the system comprising:
at least one processor configured with at least one computing device;
an electronic user interface provided by the at least one processor on the at least one computing device, wherein at least one processor is configured to execute instructions to:
process at least one selection made in the user interface that defines a threshold value associated with user input;
access a digital media library of multimedia content that includes at least one of audio and video content to provide, via the user interface, at least some of the digital multimedia content;
receive, via at least one sensor configured with the at least one computing device, user input;
process the received user input to determine that the received user input exceeds the threshold value;
provide, substantially automatically, a revised version of the digital multimedia content that is provided via the user interface by incorporating at least some of the received user input; and
generate a digital package that includes the digital multimedia content and the at least some of the received user input.

12. The system of claim 11, wherein at least one processor is configured to execute further instructions to:
transmit, via a communication interface, the package to at least one other computing device.

13. The system of claim 11, wherein the threshold value represents a maximum volume level, and the received user input that exceeds the threshold value is audio detected by a microphone that is operatively configured with the at least one computing device.

14. The system of claim 13, wherein at least some of the audio detected by the microphone is a person speaking or singing.

15. The system of claim 11, wherein at least one processor is configured to execute one or more instructions to:
select, in response to the processed received user input, at least some other of the digital multimedia content from the digital medial library, and wherein the package includes the at least some other of the digital multimedia content.

16. The system of 15, wherein the provided at least some of the digital multimedia content via the user interface includes a first version of a multimedia content, and further wherein the at least other of the digital multimedia content includes a second version of the multimedia content.

17. The system of claim 16, wherein the first version includes at least one audio and/or video portion, and wherein the second version includes less than the at least one audio and/or video portion.

18. The system of claim 11, wherein at least one processor is configured to execute one or more instructions to:
control a gate that enables or disables at least some of the multimedia content from the digital media library from being provided via the user interface.

19. The system of claim 11, wherein the threshold value represents a maximum difference between adjacent image frames in video detected by a camera configured with the at least one computing device, and the received user input that exceeds the threshold value includes video detected by the camera.

20. The system of claim 11, wherein the threshold value represents a maximum amount of movement of the at least one computing device detected by at least one motion sensor configured with the at least one computing device.
